(19) United States
(12) Patent Application Publication
(10) Pub. No.: US 2017/0090588 A1
(43) Pub. Date: Mar. 30, 2017

(54) ELECTRONIC DEVICE AND METHOD

(71) Applicant: Kabushiki Kaisha Toshiba, Tokyo (JP)

(72) Inventor: Tomohide Wakae, Hachioji Tokyo (JP)

(21) Appl. No.: 15/276,631

(22) Filed: Sep. 26, 2016

Related U.S. Application Data
(60) Provisional application No. 62/234,445, filed on Sep. 29, 2015.

(51) Int. Cl. G06F 3/01; G06F 3/038; G06F 1/32

(52) U.S. Cl. CPC G06F 3/017; G06F 3/013; G06F 3/012; G06F 1/3265; G06F 3/038

(57) ABSTRACT

According to one embodiment, an electronic device has a form of eyeglasses, and includes a first sensor, a second sensor and a hardware processor. The first sensor is configured to detect a movement of a first body part of a person who wears the device. The second sensor is configured to detect a movement of a second body part of the person. The hardware processor is configured to switch the second sensor from a non-operational state to an operational state if the first sensor detects a first movement of the first body part caused by a first gesture made by the person to provide a first instruction to the device, and to execute processing for receiving the first instruction if the second sensor switched to the operational state detects a second movement of the second body part caused by the first gesture.

### CROSS-REFERENCE TO RELATED APPLICATIONS

This application claims the benefit of U.S. Provisional Application No. 62/234,445, filed Sep. 29, 2015, the entire contents of which are incorporated herein by reference.

### FIELD

Embodiments described herein relate generally to an electronic device and a method.

### BACKGROUND

Recently, various electronic devices that the user can wear and use have been developed. Such electronic devices are called wearable devices. For example, an electronic device taking the form of eyeglasses is known. Since the lens of this kind of electronic device also functions as a screen and information can be displayed in front of the eyes without the need to hold the device in hand, it is helpful for a worker who works with both hands to use the device.

This kind of electronic device usually comprises a battery and operates on power supplied by the battery. Of this kind of electronic device, an electronic device to be worn for a long time should be small in size and weight. Therefore, a small battery is generally provided in such a device for size and weight reduction. For the above reason, this kind of electronic device must have a power saving function.

There is considerable scope for improvement in operation regarding the power saving function of this kind of electronic device. For example, the aforementioned eyeglass electronic devices have an advantage in that they need not be held in the hand, but command input by a voice is difficult in many environments, which results in requiring manual operation of a switch. The problem is not limited to the operation regarding the power saving function.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary illustration showing an example of an appearance of an electronic device of an embodiment.

FIG. 2 is an exemplary diagram showing an example of a system configuration of the electronic device of the embodiment.

FIG. 3 is an exemplary diagram showing a functional block related to suspend/resume of a controller of the electronic device of the embodiment.

FIG. 4 is an exemplary illustration of an example in which the electronic device of the embodiment detects movements of parts of the body of a user caused by a gesture by the user.

FIG. 5 is an exemplary flowchart showing a suspend process executed by the electronic device of the embodiment.

FIG. 6 is an exemplary flowchart showing a resume process executed by the electronic device of the embodiment.

FIG. 7 is an exemplary flowchart showing a resume process (modified example) executed by the electronic device of the embodiment.

### DETAILED DESCRIPTION

Various embodiments will be described hereinafter with reference to the accompanying drawings.

In general, according to one embodiment, an electronic device has a form of eyeglasses. The electronic device includes a first sensor, a second sensor and a hardware processor. The first sensor is configured to detect a movement of a first body part of a person who wears the electronic device. The second sensor is configured to detect a movement of a second body part of the person. The hardware processor is configured to switch the second sensor from a non-operational state to an operational state if the first sensor detects a first movement of the first body part caused by a first gesture made by the person to provide a first instruction to the electronic device, and to execute processing for receiving the first instruction if the second sensor switched to the operational state detects a second movement of the second body part caused by the first gesture.

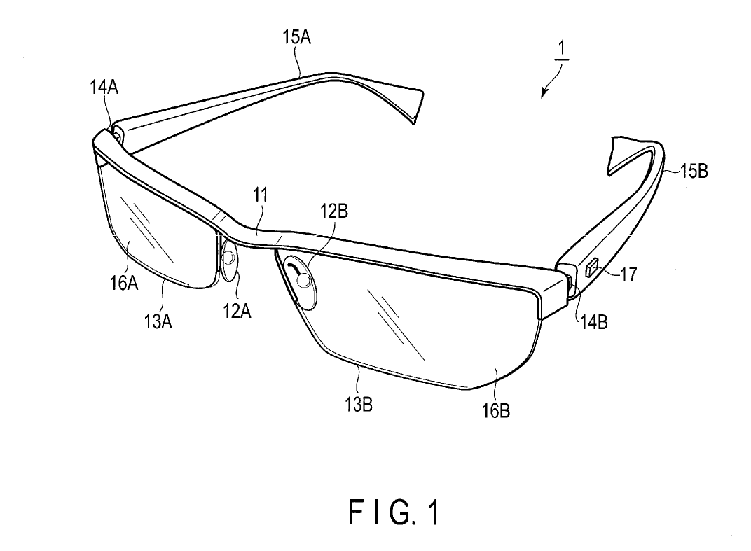

FIG. 1 is an exemplary illustration showing an example of an appearance of an electronic device of an embodiment. As shown in FIG. 1, the electronic device of the embodiment can be implemented as a wearable device 1 taking the form of eyeglasses. The wearable device 1 comprises a bridge 11, nose pads 12A and 12B, rims 13A and 13B, hinges 14A and 14B, temples 15A and 15B and lenses 16A and 16B. The bridge 11, rims 13A and 13B, hinges 14A and 14B and temples 15A and 15B are often collectively called a frame. The frame may include nose pads 12A and 12B.

Nose pads 12A and 12B are attached to the ends of rims 13A and 13B surrounding lenses 16A and 16B so as to be in contact with the user's nose and fix the wearable device 1. Rims 13A and 13B are connected to the bridge 11. Rims 13A and 13B and temples 15A and 15B are connected by hinges 14A and 14B. The frame of the wearable device 1 can be folded by hinges 14A and 14B.

One of lenses 16A and 16B can also function as a screen. It is hereinafter assumed that lens 16A functions as a screen and is also called lens/screen 16A. A projector (not shown in FIG. 1) for projecting an image on the lens/screen 16A is provided in temple 15A connected to rim 13A, in which the lens/screen 16A is fit, by hinge 14A. A switch 17 for powering on and off the wearable device 1 is provided on, for example, the side surface of temple 15B.

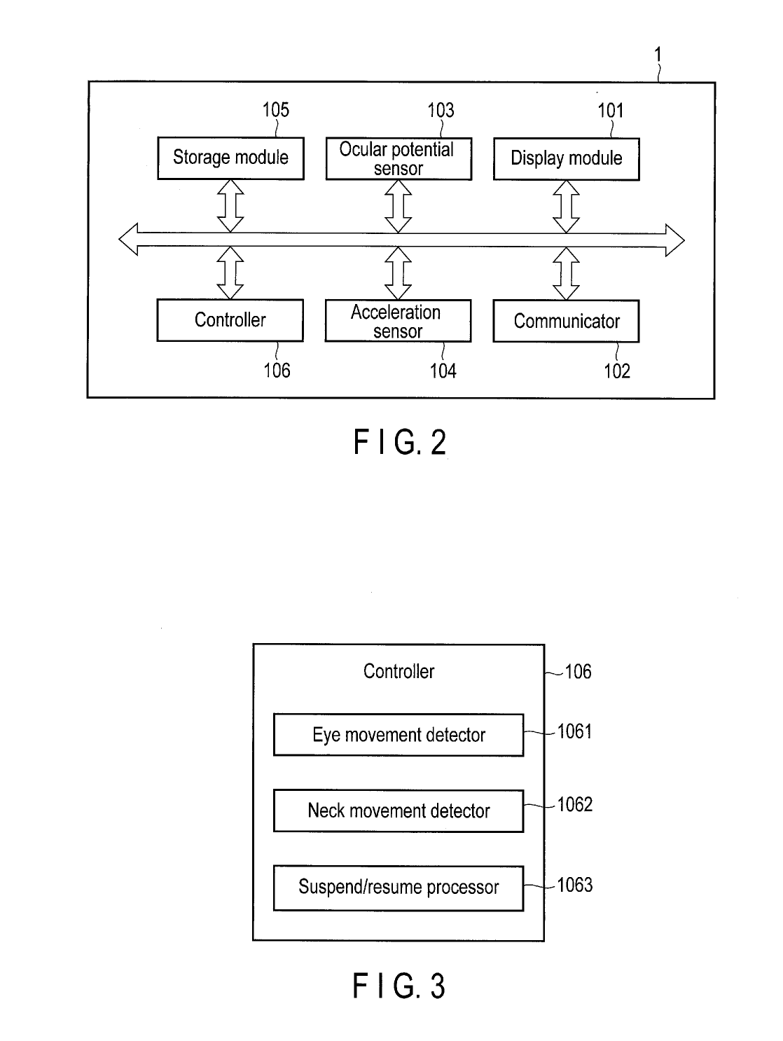

FIG. 2 is an exemplary diagram showing an example of a system configuration of the wearable device 1.

As shown in FIG. 2, the wearable device 1 comprises a display module 101, a communicator 102, an ocular potential sensor 103, an acceleration sensor 104, a storage module 105 and a controller 106.

The display module 101 is a module which controls projection (display) of image on the lens/screen 16A by the projector. The communicator 102 is a module which performs wireless communication conforming to, for example, the IEEE 802.11 standard, with an external device such as a personal computer and a smartphone. The ocular potential sensor 103 is a module used to detect movement of sight-line (eye movement). Since the cornea is positively charged and the retina is negatively charged, a potential gradient around the eyes is changed when the sight-line is moved (i.e., when the eyes are moved). The movement of sight-line (eye movement) can be detected by monitoring variations in the ocular potential sensed by the ocular potential sensor 103. Opening and closing the eyes can also be detected by monitoring variations in the ocular potential sensed by the ocular potential sensor 103.

The acceleration sensor 104 is a module used to detect neck movement. Since movement of the head (on which the eyeglass wearable device 1 is worn) caused by neck movement exhibits specific patterns depending on patterns of the neck movement, the neck movement can be detected by monitoring output values of the acceleration sensor 104 chronologically. In other words, head movement caused by neck movement can be distinguished from head movement caused by other movement.

The storage module 105 is a storage device used as a work area of various types of information processing executed by the controller 106. The controller 106 is a processor (a hardware processor) which controls the operation of the entire wearable device 1, and executes various types of information processing by using the storage module 105 as a work area. The controller 106 comprises, for example, a CPU and a flash memory, and controls each component in the wearable device 1 by firmware stored in the flash memory and executed by the CPU.

The wearable device 1 comprises a battery (not shown in FIG. 1 and FIG. 2) as a supply source for operating power, namely a power source. Since an amount of energy that can be supplied from the battery is limited, the wearable device 1 has a power saving function of, for example, temporarily switching the display module 101, the communicator 102 and the acceleration sensor 104 to a non-operational state while maintaining working environment at that time. In the description below, switching the wearable device 1 to a power saving mode is called suspend and returning the wearable device 1 from the power saving mode to a normal mode is called resume. The wearable device 1 of the embodiment aims to achieve low power consumption and improve operability including suspend/resume instructions, which will be hereinafter described in detail.

FIG. 3 is an exemplary diagram showing a functional block related to suspend/resume of the controller 106.

As shown in FIG. 3, the controller 106 comprises an eye movement detector 1061, a neck movement detector 1062 and a suspend/resume processor 1063 in connection with suspend/resume.

The eye movement detector 1061 detects, for example, a specified eye movement corresponding to a suspend instruction and a specified eye movement corresponding to a resume instruction based on variations in the ocular potential sensed by the ocular potential sensor 103. The neck movement detector 1062 detects, for example, a specified neck movement corresponding to the suspend instruction and a specified neck movement corresponding to the resume instruction based on output values from the acceleration sensor 104. The eye and neck movements corresponding to the suspend instruction may be different from or equal to the eye and neck movements corresponding to the resume instruction. It is hereinafter assumed that different movements are used for the suspend instruction and the resume instruction.

The suspend/resume processor 1063 executes processing for switching the wearable device 1 to the power saving mode (i.e., suspends the wearable device 1), for example, when the wearable device 1 is in the normal mode, the eye movement detector 1061 detects the specified eye movement corresponding to the suspend instruction and the neck movement detector 1062 detects the specified neck movement corresponding to the suspend instruction.

The wearable device 1 of the embodiment is configured such that the ocular potential sensor 103 is in an operational state but the acceleration sensor 104 is basically in a non-operational state in order to reduce power consumption when the wearable device 1 is in the normal mode. Therefore, if the eye movement detector 1061 detects the specified eye movement corresponding to the suspend instruction when the wearable device 1 is in the normal mode, the suspend/resume processor 1063 first switches the acceleration sensor 104 from the non-operational state to the operational state. If the neck movement detector 1062 detects the specified neck movement corresponding to the suspend instruction by the acceleration sensor 104 switched to the operational state, the suspend/resume processor 1063 executes processing for switching the wearable device 1 to the power saving mode. If the specified neck movement is not detected, the suspend/resume processor 1063 returns the acceleration sensor 104 to the non-operational state.

That is, when detecting a specified gesture by sensors, all the sensors are not operated from the beginning in the wearable device 1 of the embodiment. Instead, part of the sensors is first used for detecting a specified movement in order to reduce power consumption. Then, all the sensors are used for confirming the user's intention in order to prevent an operating error.

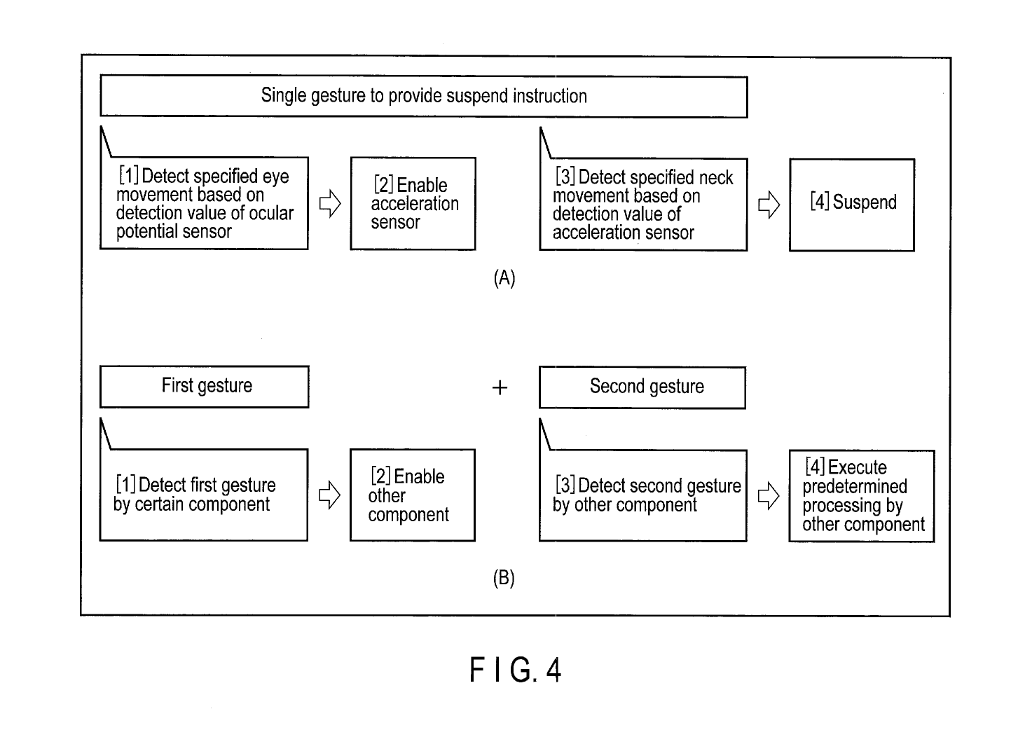

Some existing electronic devices are also configured to, when a certain component detects a specified event, switch the other non-operational component to the operational state (i.e., basically maintain the other component in the non-operational state) in order to reduce power consumption. However, the wearable device 1 of the embodiment is different from the conventional devices in that movements of parts of the body (eyes and neck) caused by a single gesture made by the user to provide, for example, a suspend instruction, are detected by sensors (ocular potential sensor 103 and acceleration sensor 104), and a process of detecting the gesture includes a step of switching a non-operational sensor (acceleration sensor 104) to the operational state in accordance with a detection value of an operating sensor (ocular potential sensor 103). The difference is hereinafter described in detail with reference to FIG. 4.

It is assumed that the user makes a gesture “lowering the head with the eyes closed” in order to provide a suspend instruction. In the wearable device 1 of the embodiment, when the user makes this gesture, the eye movement detector 1061 first detects that the eyes are closed for a certain time as shown in FIG. 4 (A) (FIG. 4 (A) [1]). In response to the detection result by the eye movement detector 1061, the suspend/resume processor 1063 switches the acceleration sensor 104 from the non-operational state to the operational state (FIG. 4 (A) [2]). Since the acceleration sensor 104 is switched to the operational state, the neck movement detector 1062 detects a neck movement to lower the head (FIG. 4 (A) [3]). In response to the detection result by the neck movement detector 1062, the suspend/resume processor 1063 executes processing for switching the wearable device 1 to the power saving mode (FIG. 4 (A) [4]).

It is assumed that the user makes a gesture “raising the head while blinking” in order to provide a resume instruction. The eye movement detector 1061 detects that the eyes are repeatedly opened and closed, the neck movement detector 1062 detects a neck movement to raise the head by the functioning of the acceleration sensor 104, and the suspend/resume processor 1063 executes processing for returning the wearable device 1 to the normal mode.

In the wearable device 1 of the embodiment, the user just makes a single gesture to input a desired command to suspend or resume. Since time required for detecting the specified movement by the eye movement detector 1061 based on output values of the ocular potential sensor 103 and enabling the acceleration sensor 104 by the suspend/resume processor 1063 is sufficiently short in comparison with time required for the user to make the single gesture, the neck movement detector 1062 can detect the specified movement based on output values of the acceleration sensor 104 without any problem.

In contrast, in the aforementioned existing electronic devices, the process shown in FIG. 4 (B) is executed to switch the non-operational component to the operational state when a certain component detects a specified event.

For example, when the user makes a specified gesture, a certain component detects the specified gesture (FIG. 4 (B) [1]) and the other component is switched from the non-operational state to the operational state (FIG. 4 (B) [2]). After that, when the user makes the other specified gesture, the other component detects the other specified gesture (FIG. 4 (B) [3]) and executes predetermined processing (FIG. 4 (B) [4]). Therefore, the conventional process of detecting a single gesture made by the user to input a command does not include a step of switching a non-operational component to the operational state by an operating component.

In the embodiment, a gesture made by the user to provide any instruction is detected by eye and neck movements, i.e., by the ocular potential sensor 103 and the acceleration sensor 104. However, the sensors are not limited to those and various sensors may be applied. In the embodiment, the sensors are switched in two levels, i.e., the acceleration sensor 104 is enabled when the specified movement is detected by the ocular potential sensor 103. However, the sensors may be switched in three or more levels. Further, two sensors may be enabled when the specified movement is detected by one sensor. Furthermore, a movement of a part or the body may be detected by several sensors. When a certain sensor detects the specified movement in this case, the other sensor may be enabled.

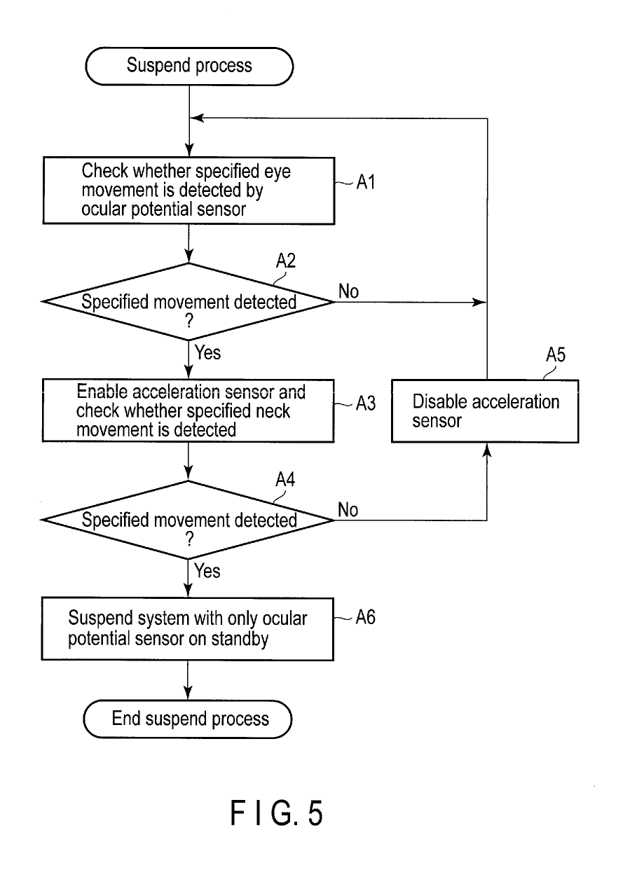

FIG. 5 is an exemplary flowchart showing a suspend process executed by the wearable device 1 of the embodiment.

First, the eye movement detector 1061 checks whether a specified eye movement is detected by the ocular potential sensor 103 (block A1). If the eye movement detector 1061 detects the specified movement (YES in block A2), the suspend/resume processor 1063 enables the acceleration sensor 104 and the neck movement detector 1062 checks whether a specified neck movement is detected by the acceleration sensor 104 (block A3). If the specified movement is not detected (NO in block A4), the suspend/resume processor 1063 disables the acceleration sensor 104 (block A5).

If the neck movement detector 1062 detects the specified movement (YES in block A4), the suspend/resume processor 1063 switches the wearable device 1 to the power saving mode (block A6). At this time, the ocular potential sensor 103 is maintained in the operational state.

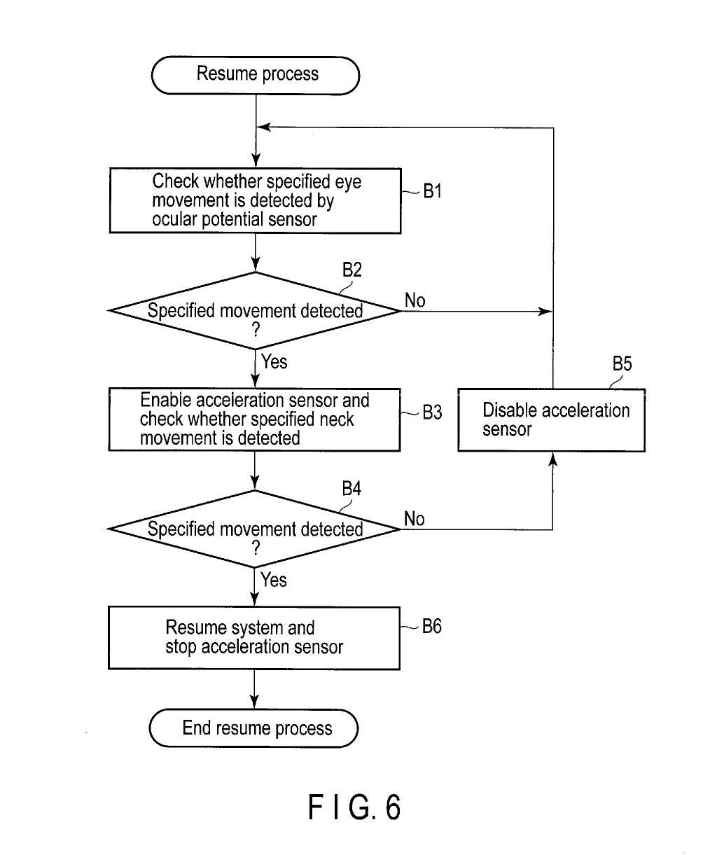

FIG. 6 is an exemplary flowchart showing a resume process executed by the wearable device 1 of the embodiment.

First, the eye movement detector 1061 checks whether a specified eye movement is detected by the ocular potential sensor 103 (block B1). If the eye movement detector 1061 detects the specified movement (YES in block B2), the suspend/resume processor 1063 enables the acceleration sensor 104 and the neck movement detector 1062 checks whether a specified neck movement is detected by the acceleration sensor 104 (block B3). If the specified movement is not detected (NO in block B4), the suspend/resume processor 1063 disables the acceleration sensor 104 (block B5).

If the neck movement detector 1062 detects the specified movement (YES in block B4), the suspend/resume processor 1063 returns the wearable device 1 from the power saving mode to the normal mode and disables the acceleration sensor 104 (block B6).

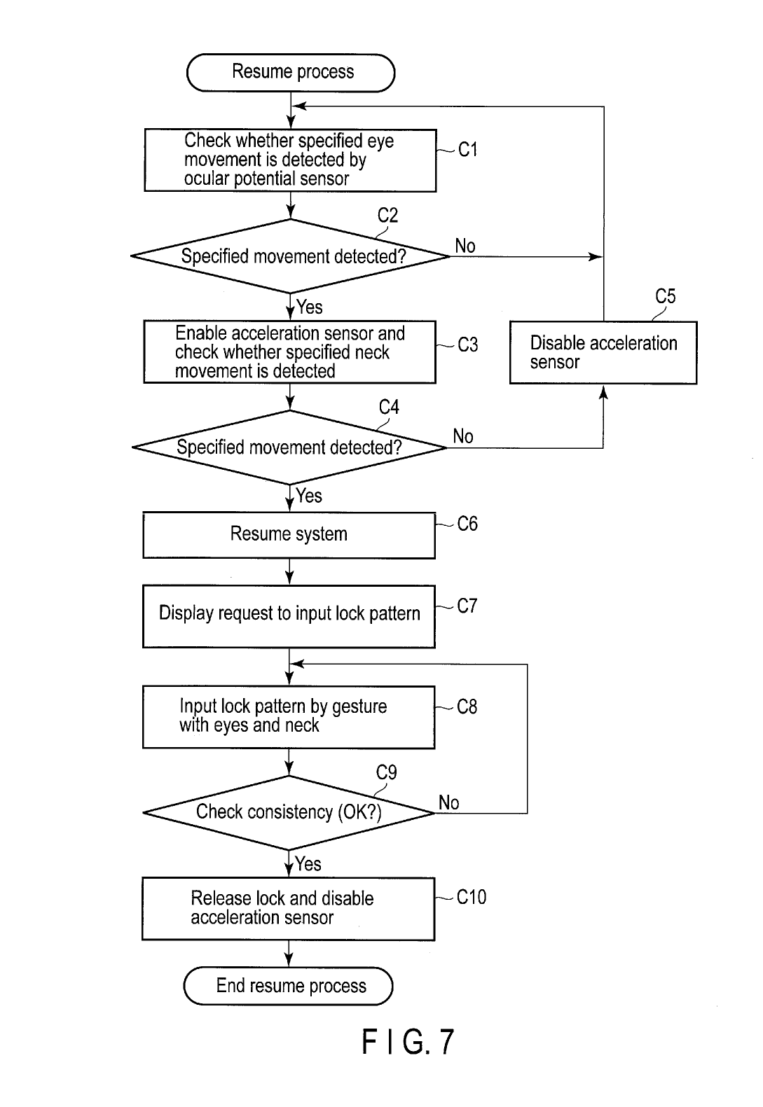

FIG. 7 is an exemplary flowchart showing a resume process (modified example) executed by the wearable device 1 of the embodiment.

For example, in a personal computer etc., it is possible to request the user to input a password at the time of resume in order to confirm whether the user is a valid user. In the wearable device 1 of the embodiment, a gesture can also be used for such user authentication.

First, the eye movement detector 1061 checks whether a specified eye movement is detected by the ocular potential sensor 103 (block C1). If the eye movement detector 1061 detects the specified movement (YES in block C2), the suspend/resume processor 1063 enables the acceleration sensor 104 and the neck movement detector 1062 checks whether a specified neck movement is detected by the acceleration sensor 104 (block C3). If the specified movement is not detected (NO in block C4), the suspend/resume processor 1063 disables the acceleration sensor 104 (block C5).

If the neck movement detector 1062 detects the specified movement (YES in block C4), the suspend/resume processor 1063 returns the wearable device 1 from the power saving mode to the normal mode (block C6).

Next, the suspend/resume processor 1063 requests the user to input a lock pattern by the display module 101 (block C7). The user inputs the lock pattern by making a gesture with the eyes and neck (block C8). If the eye movement detector 1061 and the neck movement detector 1062 detect specified movements (YES in block C9), the suspend/resume processor 1063 releases the lock and disables the acceleration sensor 104 (block C10).

As described above, the wearable device 1 of the embodiment can achieve low power consumption and improve operability including suspend/resume instructions.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising a form of eyeglasses, the device comprising:
a first sensor configured to detect a movement of a first body part of a person who wears the electronic device;
a second sensor configured to detect a movement of a second body part of the person; and
a hardware processor configured to switch the second sensor from a non-operational state to an operational state if the first sensor detects a first movement of the first body part caused by a first gesture made by the person to provide a first instruction to the electronic device, and to execute processing for receiving the first instruction if the second sensor switched to the operational state detects a second movement of the second body part caused by the first gesture.

2. The electronic device of claim 1, wherein the first sensor comprises an ocular potential sensor.

3. The electronic device of claim 2, wherein the hardware processor is further configured to detect an eye movement or opening and closing eyes as the movement of the first body part based on a detection value of the first sensor.

4. The electronic device of claim 1, wherein the second sensor comprises an acceleration sensor.

5. The electronic device of claim 4, wherein the hardware processor is further configured to detect a neck movement as the movement of the second body part based on a detection value of the second sensor.

6. The electronic device of claim 1, wherein the first instruction comprises an instruction to switch the electronic device to a power saving mode.

7. The electronic device of claim 6, wherein:
the first sensor is maintained in the operational state while the electronic device is in the power saving mode; and
the hardware processor is further configured to switch the second sensor from the non-operational state to the operational state if the first sensor detects a second movement of the first body part caused by a second gesture made by the person while the electronic device is in the power saving mode, and returns the electronic device from the power saving mode to a normal mode if the second sensor switched to the operational state detects the second movement of the second body part caused by the second gesture.

8. The electronic device of claim 1, wherein the hardware processor is further configured to switch the second sensor to the non-operational state if the second sensor does not detect the second movement of the second body part after the first sensor detects the first movement of the first body part.

9. The electronic device of claim 1, wherein the hardware processor comprises means for switching the second sensor from the non-operational state to the operational state if the first sensor detects the first movement of the first body part caused by the first gesture made by the person to provide the first instruction to the electronic device, and executing the processing for receiving the first instruction if the second sensor switched to the operational state detects the second movement of the second body part caused by the first gesture.

10. A method executed by an electronic device comprising a form of eyeglasses, the method comprising:
switching, if a first sensor detects a first movement of a first body part of a person who wears the electronic device caused by a first gesture made by the person to provide a first instruction to the electronic device, a second sensor from a non-operational state to an operational state, the first sensor being for detecting a movement of the first body part, the second sensor being for detecting a movement of the second body part; and
receiving the first instruction if the second sensor switched to the operational state detects a second movement of the second body part caused by the first gesture.

11. The method of claim 10, wherein the first sensor comprises an ocular potential sensor.

12. The method of claim 11, wherein the receiving the first instruction comprises detecting an eye movement or opening and closing eyes as the movement of the first body part based on a detection value of the first sensor.

13. The method of claim 10, wherein the second sensor comprises an acceleration sensor.

14. The method of claim 13, wherein the receiving the first instruction comprises detecting a neck movement as the movement of the second body part based on a detection value of the second sensor.

15. The method of claim 10, wherein the first instruction comprises an instruction to switch the electronic device to a power saving mode.

16. The method of claim 15, wherein:
the first sensor is maintained in the operational state while the electronic device is in the power saving mode; and
the receiving the first instruction comprises switching the second sensor from the non-operational state to the operational state if the first sensor detects a second movement of the first body part caused by a second gesture of the person while the electronic device is in the power saving mode, and returning the electronic device from the power saving mode to a normal mode if the second sensor switched to the operational state detects the second movement of the second body part caused by the second gesture.

17. The method of claim 10, wherein the receiving the first instruction comprises switching the second sensor to the non-operational state if the second sensor does not detect the second movement of the second body part after the first sensor detects the first movement of the first body part.
